(19) United States
(12) Patent Application Publication
(10) Pub. No.: US 2003/0215222 A1
(43) Pub. Date: Nov. 20, 2003

(54) Hard disk recorder and information recording reproducing apparatus

(75) Inventor: Mitsuhiko Kawasaki, Osaka (JP)

Correspondence Address: MORGAN LEWIS & BOCKIUS LLP, 1111 PENNSYLVANIA AVENUE NW, WASHINGTON, DC, 20004, US

(73) Assignee: Funai Electric Co., Ltd.

(21) Appl. No.: 10/421,691

(22) Filed: Apr. 24, 2003

(30) Foreign Application Priority Data
Apr. 25, 2002 (JP) P2002-124410

(51) Int. Cl. H04N 5/781

(52) U.S. Cl. 386/125; 386/126

(57) ABSTRACT

When an interval is designated by pushing a specific button at the time of displaying video desiring to be deleted and again pushing the specific button at the time of completing the video desiring to be deleted while reproduced video displayed on a television monitor is viewed, video in the interval from a point in the time when the button is pushed at the first time to a point in time when it is pushed at the second time is deleted. At the time of the next production, only necessary video can be reproduced.

The present disclosure relates to the subject matter contained in Japanese Patent Application No. 2002-124410 filed Apr. 25, 2002, which is incorporated herein by reference in its entirety.

### BACKGROUND OF THE INVENTION

1. Field of the Invention

The present invention relates to an information recording reproducing apparatus such as a hard disk recorder for recording a television program etc. on a hard disk.

2. Description of the Related Art

A hard disk recorder is an apparatus for recording video input from the outside on a hard disk and reproducing the video, and has an advantage that video recorded as digital data can be read from the hard disk and be edited as desired. For example, by performing editing for deleting an unnecessary video portion from recorded video and leaving only a necessary portion, reproduction can be performed by the edited video from the next time.

A method of editing for deleting an unnecessary portion and leaving only a necessary portion in a hard disk recorder is described in JP-A-2000-285653. In this publication, when a user performs an operation of deletion during reproduction, a code such as 0000h representing a space area is set in a corresponding FAT (File Allocation Table) area of a cluster in which the deletion is instructed and data recorded in this cluster is set in an access difficult state and is deleted. This is repeated in cluster units until the deletion completion is instructed and when the user performs an operation of the deletion completion, a cluster number is set so that a cluster immediately before the deletion is connected to a cluster immediately after the deletion. As a result of this, at the time of the next reproduction, reproduction is performed so as to jump video of the deleted cluster.

However, in the method described in the publication, since it is constructed so that a space area code is set in the FAT area and recorded data is set in an access difficult state and thereby the data is deleted, it is necessary to manage a cluster number, for example, cluster number setting for connecting clusters before and after the deletion, and there is a problem that a processing procedure becomes complicated.

### SUMMARY OF THE INVENTION

The invention is devised to solve the problem, and an object of the invention is to easily perform edit processing for deleting an unnecessary portion of information and leaving only a necessary portion without the need for complicated processing.

The invention is constructed so that there is provided a recording part for copying and recording reproduced information at the time of reproducing recorded information. When reproducing and editing information, information in an interval designated by an operation of a specific button provided in a remote control is skipped or left and only necessary information is recorded in the recording part. Reproduction is performed based on the information recorded in the recording part at the time of the next reproduction. In the case of designating an interval, for example, an interval from a point in time when the specific button is pushed at the first time to a point in time when it is pushed at the second time may be set to a designated interval, or an interval from a point in time when the specific button is pushed to a point in time when it is released may be set to a designated interval.

In the invention, an interval for deleting or leaving information is designated by operating the specific button. In the case of deleting the information, information in the designated interval is skipped automatically and reproduced information in which the information in the designated interval is cut is recorded in the recording part. Also, in the case of leaving the information, only the information in the designated interval is recorded in the recording part and other information is cut. Thus, edited information is recorded in the recording part. At the time of the next reproduction, only the necessary information is reproduced by performing reproduction based on the information recorded in this recording part. In the invention, in the case of deleting unnecessary information, it has only to be constructed so that information in the designated interval is skipped and is not recorded at the time of recording in the recording part, and also in the case of leaving necessary information, only information in the designated interval has only to be recorded at the time of recording in the recording part, so that there is no need to manage a cluster number and editing processing can be performed very simply.

In the invention, editing processing for skipping or leaving information in the designated interval is preferably performed when the specific button is operated in a state where an editing mode is set. According to this, at the time of normal reproduction, there is no need to copy reproduced video to the recording part, so that processing is more simplified and a load of a CPU can be reduced.

In the above case, in setting of the editing mode, it may be constructed so as to make transition to the editing mode automatically when the specific button has been pushed down for a certain time or longer. According to this, mode setting and editing work can be performed by one button and it becomes easy for a user to perform an operation and ease of use improves.

Also, in the invention, it is preferably constructed so as to be able to select whether to skip or leave information in the interval designated by the specific button. According to this, a user can freely select any mode in consideration of ease of use.

Also, in a hard disk recorder according to the invention, a hard disk comprises a first area in which video information is recorded at the time of recording and a second area in which the video information is copied and recorded at the time of reproducing the video information recorded in the first area. When reproducing and editing recorded video of the first area, video in an interval from a point in time of the first pushdown of a specific button to a point in time of the second pushdown of the specific button or video in an interval in which a specific button has been pushed down among reproduced video displayed on a monitor is skipped or left and only the necessary video information is recorded in the second area.

### BRIEF DESCRIPTION OF THE DRAWINGS

FIG. 1 is a block diagram of a hard disk recorder according to one embodiment of the invention;

FIG. 2 is a view showing an operation part of a remote control;

FIGS. 3(a) and 3(b) are diagrams describing an editing principle according to a first embodiment;

FIGS. 4(a) and 4(b) are diagrams describing the editing principle according to the first embodiment;

FIGS. 5(a) and 5(b) are diagrams describing an editing principle according to a second embodiment;

FIGS. 6(a) and 6(b) are diagrams describing the editing principle according to the second embodiment;

FIGS. 7(a) and 7(b) are diagrams describing an editing principle according to a third embodiment;

FIGS. 8(a) and 8(b) are diagrams describing the editing principle according to the third embodiment;

FIGS. 9(a) and 9(b) are diagrams describing an editing principle according to a fourth embodiment;

FIGS. 10(a) and 10(b) are diagrams describing the editing principle according to the fourth embodiment;

FIG. 11 is one example of a setting screen of a television monitor; and

FIG. 12 is one example of a confirmation screen of the television monitor.

### DETAILED DESCRIPTION OF THE PREFFERED EMBODIMENTS

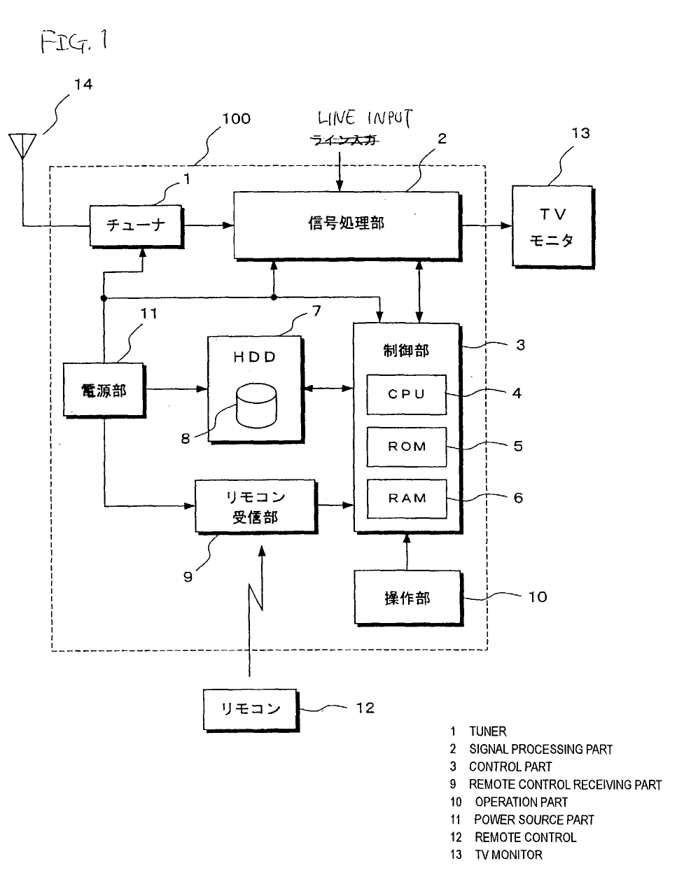

FIG. 1 shows a block diagram of a hard disk recorder according to one embodiment of the invention. In the drawing, a block surrounded by a broken line is a hard disk recorder 100. Numeral 1 is a tuner for taking a signal of a predetermined channel out of a signal received by an antenna 14, and numeral 2 is a signal processing part for processing a video signal and a sound signal taken out by the tuner 1, and numeral 3 is a control part comprising a CPU 4, ROM 5 and RAM 6, and numeral 7 is a hard disk drive for performing readout or writing of information with respect to a hard disk 8. The hard disk 8 constitutes recording means in the invention. Numeral 9 is a remote control receiving part for receiving a control signal from a remote control 12, and numeral 10 is an operation part provided in a main body of the hard disk recorder 100, and numeral 11 is a power source part for supplying a power source to each the part, and numeral 13 is a television monitor for displaying video reproduced by the hard disk recorder 100. Incidentally, a signal from an external device such as a video camera can also be input to the hard disk recorder 100 and this signal is captured to the signal processing part 2 as a line input.

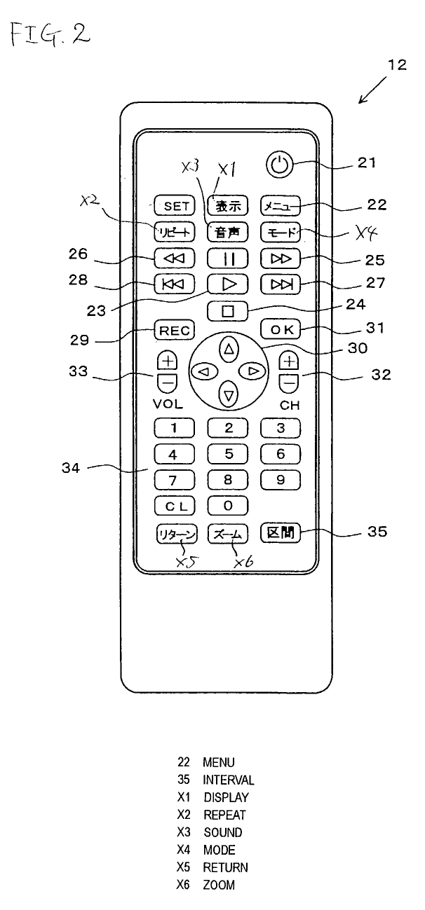

FIG. 2 is a view showing an operation part of the remote control 12. Numeral 21 is a power source button for turning on or off a power source, and numeral 22 is a menu button for displaying a menu on a screen of the television monitor 13, and numeral 23 is a reproduction button for starting a reproduction, and numeral 24 is a stop button for stopping reproduction, and numeral 25 is a fast-forward button, and numeral 26 is a fast-rewind button, and numeral 27 is a skip button of a feed direction, and numeral 28 is a skip button of a back direction, and numeral 29 is a recording button for starting recording. Numeral 30 is a cursor button for moving a cursor on the screen of the television monitor 13, and numeral 31 is an OK button for determining an item selected by the cursor, and numeral 32 is a channel selection button for selecting a channel, and numeral 33 is a sound volume button for adjusting sound volume, and numeral 34 is a ten-key pad for inputting numeric characters. Numeral 35 is an interval button for designating an interval and deleting or leaving recorded video. This button constitutes a specific button in the invention. In addition to the buttons described above, various buttons are provided in the remote control 12 but are not a main part of the invention, so that description is omitted.

Next, an operation of the hard disk recorder 100 will be described. In the case of making recording in FIG. 1, when the recording button 29 of the remote control 12 is operated, the remote control receiving part 9 receives a signal of a recording command and sends the signal to the control part 3, and the control part 3 executes a control procedure for a recording action. As a result of this, a signal received by the antenna 14 or a signal input from the external device is digitized in the signal processing part 2 and is recorded on the hard disk 8 by the hard disk drive 7 through the control part 3. Also, in the case of reproducing recorded video, when the reproduction button 23 of the remote control 12 is operated after a list of record contents of the hard disk 8 is displayed on the screen of the television monitor 13 to select a title, the remote control receiving part 9 receives a signal of a reproduction command and sends the signal to the control part 3, and the control part 3 executes a control procedure for a reproduction action. As a result of this, data recorded on the hard disk 8 is read out by the control part 3 and is converted into an analog signal in the signal processing part 2 and then reproduced video is displayed on the television monitor 13. The above is the operation of normal recording and reproduction, and is not different from the conventional operation.

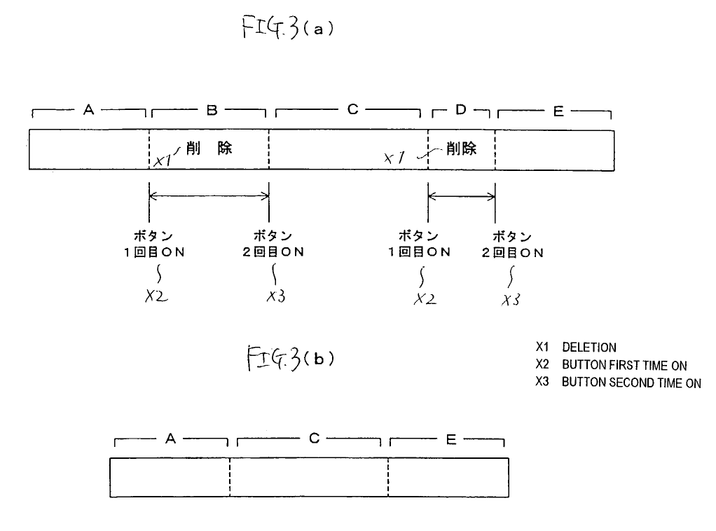

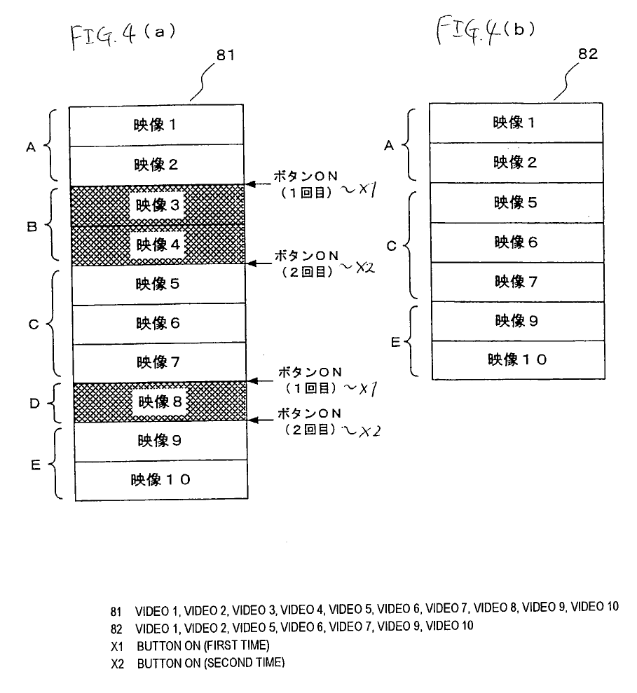

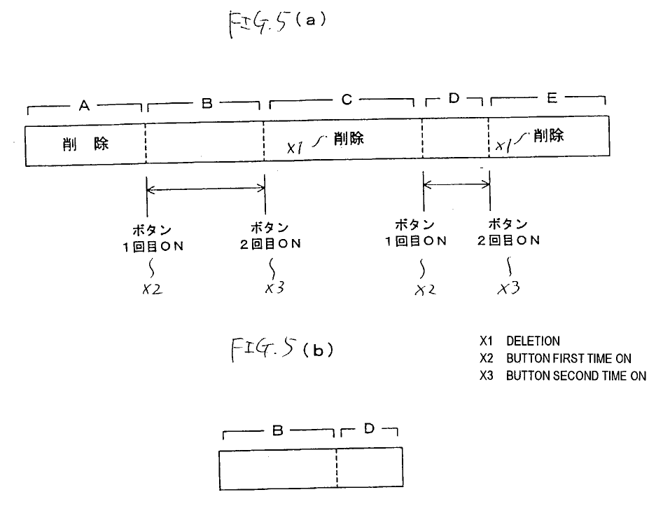

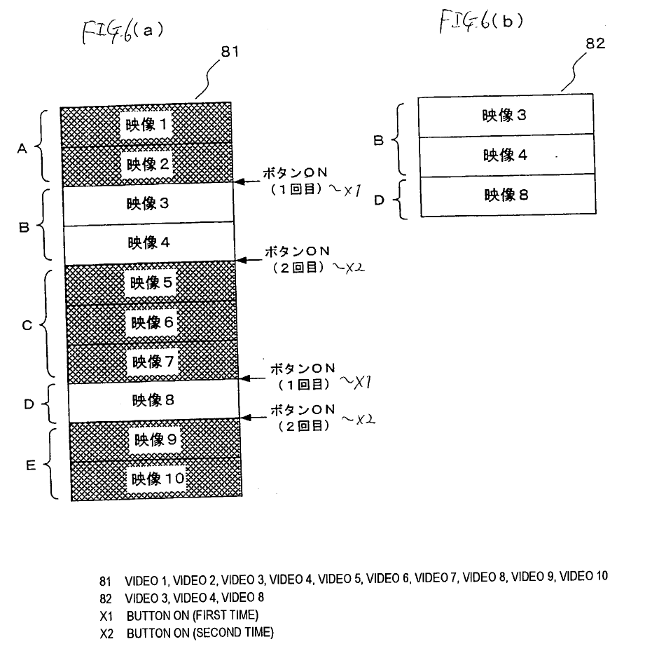

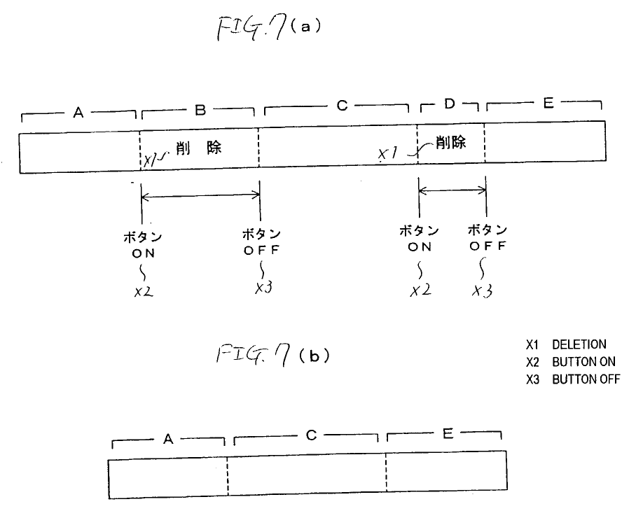

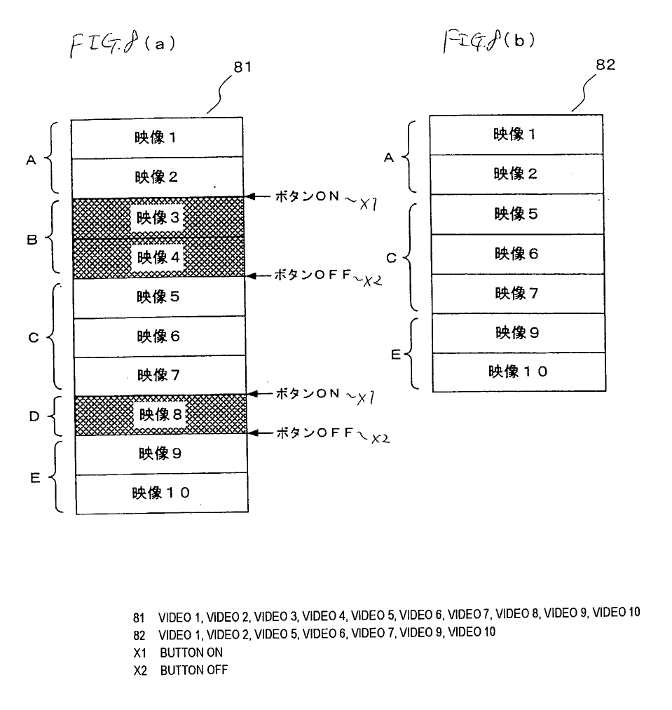

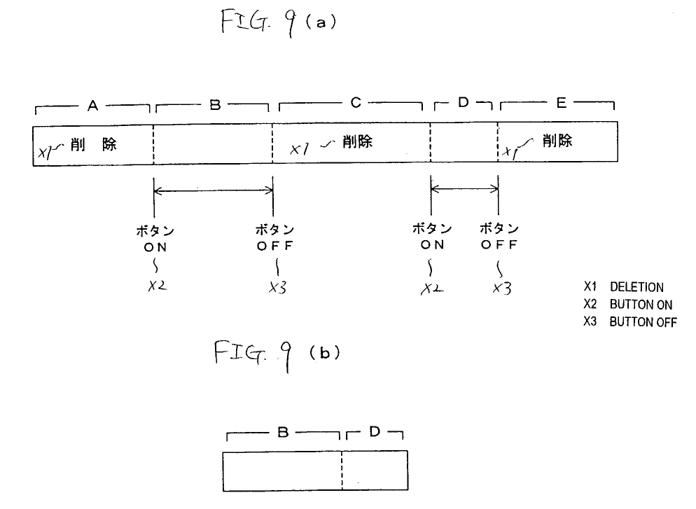

Next, an operation of the case of editing recorded video will be described. FIGS. 3(a) to 4(b) are diagrams describing an editing principle according to a first embodiment. The first embodiment is constructed so as to delete video in an interval from a point in time when the interval button 35 of the remote control 12 is pushed at the first time to a point in time when it is pushed at the second time. That is, while the hard disk recorder 100 is set to a reproduction state and video displayed on the television monitor 13 is viewed, the interval button 35 is pushed at the time of displaying video desiring to be deleted and the interval button 35 is again pushed at the time of completing the video desiring to be deleted. By performing such an operation, video in an interval from a point in time when the interval button 35 is pushed at the first time to a point in time when it is pushed at the second time is deleted as shown in FIG. 3(a). A to E of the drawing represent blocks of reproduced video and here, a video block B and a video block D are deleted by an operation of the interval button 35. The video blocks B and D are, for example, blocks of commercial video. As a result of deleting the unnecessary video blocks thus, recorded video is edited to video made of only the necessary video blocks A, C and E as shown in FIG. 3(b).

The editing described above is performed on the hard disk by a method as shown in FIGS. 4(a) and 4(b). FIGS. 4(a) and 4(b) are diagrams schematically showing the record contents of the hard disk 8. The hard disk 8 comprises an area 81 shown in FIG. 4(a) and an area 82 shown in FIG. 4(b). The area 81 is an area in which video information is recorded at the time of recording, and constitutes a first area in the invention. The area 82 is an area in which the video information is copied and recorded at the time of reproducing the video information recorded in the area 81, and constitutes a second area in the invention. At the time of reproduction, video information (video 1 to video 10) recorded in the area 81 is sequentially read out and is displayed on the television monitor 13 and reproduced video is copied to the area 82 in parallel with this reproduction. At this time, video information in an interval from a point in time of the first pushdown of the interval button 35 to a point in time of the second pushdown is not copied to the area 82 and is skipped. As shown in FIGS. 4(a) and 4(b), video information (video 3, video 4) included in a video block B and video information (video 8) included in a video block D are skipped. As a result of this, video information excluding the skipped video information is recorded in the area 82. Therefore, at the time of the next reproduction, only necessary video can be reproduced by reading out and reproducing the edited video information of the area 82. Incidentally, when “deleting” is displayed on the television monitor 13 during the range from the first pushdown of the interval button 35 to the second pushdown and “completion of deletion” is displayed at a point in time of the second pushdown of the interval button 35, an audience can perform an accurate operation without confusing the start and completion of deletion even in the case of operating the interval button again and again during reproduction.

FIGS. 5(a) to 6(b) are diagrams describing an editing principle according to a second embodiment. The second embodiment is constructed so as to leave video in an interval from a point in time when the interval button 35 of the remote control 12 is pushed at the first time to a point in time when it is pushed at the second time opposite to the first embodiment. That is, while the hard disk recorder 100 is set to a reproduction state and video displayed on the television monitor 13 is viewed, the interval button 35 is pushed at the time of displaying video desiring to be left. Then, the interval button 35 is again pushed at the time of completing the video desiring to be left. By performing such an operation, only video in an interval from a point in time when the interval button 35 is pushed at the first time to a point in time when it is pushed at the second time is left and the other video is deleted as shown in FIG. 5(a). A to E of the drawing represent blocks of reproduced video and here, by an operation of the interval button 35, a video block B and a video block D are left and video blocks A, C, E are deleted. As a result of deleting the unnecessary video blocks thus, recorded video is edited to video made of only the necessary video blocks B and D as shown in FIG. 5(b).

The editing described above is performed on the hard disk by a method as shown in FIGS. 6(a) and 6(b9. FIGS. 6(a) and 6(b) are diagrams schematically showing the record contents of the hard disk 8. The hard disk 8 comprises an area 81 shown in FIG. 6(a) and an area 82 shown in FIG. 6(b). The area 81 is an area in which video information is recorded at the time of recording, and constitutes a first area in the invention. The area 82 is an area in which the video information is copied and recorded at the time of reproducing the video information recorded in the area 81, and constitutes a second area in the invention. At the time of reproduction, video information (video 1 to video 10) recorded in the area 81 is sequentially read out and is displayed on the television monitor 13 and reproduced video is copied to the area 82 in parallel with this reproduction. At this time, only video information in an interval from a point in time of the first pushdown of the interval button 35 to a point in time of the second pushdown is copied to the area 82. As shown in FIGS. 6(a) and 6(B), video information (video 3, video 4) included in a video block B and video information (video 8) included in a video block D are copied to the area 82 and the other video information is skipped. Therefore, at the time of the next reproduction, only necessary video can be reproduced by reading out and reproducing the edited video information of the area 82. Incidentally, when “preserving video” is displayed on the television monitor 13 during the range from the first pushdown of the interval button 35 to the second pushdown and “completion of preservation” is displayed at a point in time of the second pushdown of the interval button 35, an audience can perform an accurate operation without confusing the start and completion of preservation even in the case of operating the interval button again and again during reproduction.

FIGS. 7(a) to 8(b) are diagrams describing an editing principle according to a third embodiment. The third embodiment is a modified example of the first embodiment. In the first embodiment, a deletion interval is designated by pushing the interval button twice, but the third embodiment is constructed so as to delete video in an interval in which the interval button 35 has been pushed down. That is, while the hard disk recorder 100 is set to a reproduction state and video displayed on the television monitor 13 is viewed, the interval button 35 is pushed at the time of displaying video desiring to be deleted and this pushdown state is maintained. Then, the interval button 35 is released at the time of completing the video desiring to be deleted. By performing such an operation, video in an interval from the push of the interval button 35 to the release of the interval button 35 is deleted as shown in FIG. 7(a). A to E of the drawing represent blocks of reproduced video. Here, a video block B and a video block D are deleted by an operation of the interval button 35. The video blocks B and D are, for example, blocks of commercial video. As a result of deleting the unnecessary video blocks thus, recorded video is edited to video made of only the necessary video blocks A, C and E as shown in FIG. 7(b).

The editing described above is performed on the hard disk by a method as shown in FIGS. 8(a) and 8(b). FIGS. 8(a) and 8(b) are diagrams schematically showing the record contents of the hard disk 8 The hard disk 8 comprises an area 81 shown in FIG. 8(a) and an area 82 shown in FIG. 8(b). The area 81 is an area in which video information is recorded at the time of recording, and constitutes a first area in the invention. The area 82 is an area in which the video information is copied and recorded at the time of reproducing the video information recorded in the area 81, and constitutes a second area in the invention. At the time of reproduction, video information (video 1 to video 10) recorded in the area 81 is sequentially read out and is displayed on the television monitor 13 and reproduced video is copied to the area 82 in parallel with this reproduction. At this time, video information in an interval from a point in time when the interval button 35 is pushed to a point in time when it is released is not copied to the area 82 and is skipped. As shown in FIGS. 8(a) and 8(b), video information (video 3, video 4) included in a video block B and video information (video 8) included in a video block D are skipped. As a result of this, video information excluding the skipped video information is recorded in the area 82. Therefore, at the time of the next reproduction, only necessary video can be reproduced by reading out and reproducing the edited video information of the area 82. Incidentally, also in the embodiment, “deleting” may be displayed on the television monitor 13 during the push of the interval button 35 and “completion of deletion” may be displayed at a point in time of the release of the interval button 35.

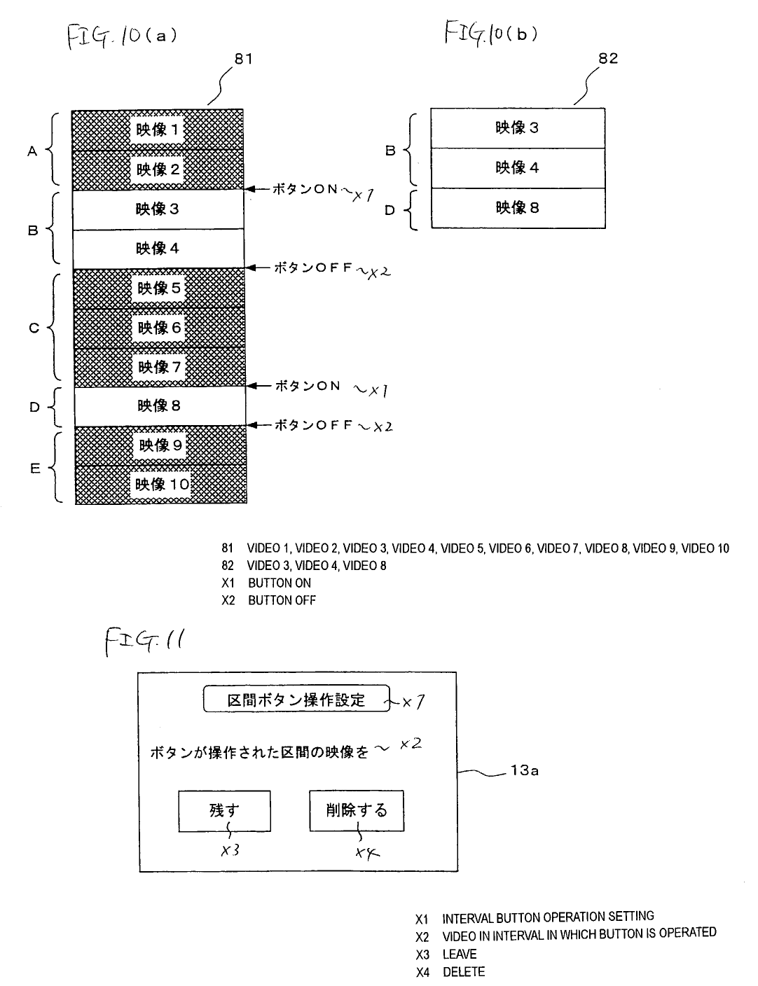

FIGS. 9(a) to 10(b) are diagrams describing an editing principle according to a fourth embodiment. The fourth embodiment is a modified example of the second embodiment. In the second embodiment, an interval for leaving video is designated by pushing the interval button twice, but the fourth embodiment is constructed so as to leave video in an interval in which the interval button 35 has been pushed down. That is, while the hard disk recorder 100 is set to a reproduction state and video displayed on the television monitor 13 is viewed, the interval button 35 is pushed at the time of displaying video desiring to be left and this pushdown state is maintained. Then, the interval button 35 is released at the time of completing the video desiring to be left. By performing such an operation, as shown in FIG. 9(a), only video in an interval from the push of the interval button 35 to the release of the interval button 35 is left and the other video is deleted. A to E of the drawing represent blocks of reproduced video. Here, a video block B and a video block D are left by an operation of the interval button 35 and video blocks A, C, E are deleted. As a result of deleting the unnecessary video blocks thus, recorded video is edited to video made of only the necessary video blocks B, D as shown in FIG. 9(b).

The editing described above is performed on the hard disk by a method as shown in FIGS. 10(a) and 10(b). FIGS. 10(a) and 10(b) are diagrams schematically showing the record contents of the hard disk 8. The hard disk 8 comprises an area 81 shown in FIG. 10(a) and an area 82 shown in 10(b). The area 81 is an area in which video information is recorded at the time of recording, and constitutes a first area in the invention. The area 82 is an area in which the video information is copied and recorded at the time of reproducing the video information recorded in the area 81, and constitutes a second area in the invention. At the time of reproduction, video information (video 1 to video 10) recorded in the area 81 is sequentially read out and is displayed on the television monitor 13 and reproduced video is copied to the area 82 in parallel with this reproduction. At this time, only video information in an interval from a point in time when the interval button 35 is pushed to a point in time when it is released is copied to the area 82. As shown in FIGS. 10(a) and 10(b), video information (video 3, video 4) included in a video block B and video information (video 8) included in a video block D are copied to the area 82 and the other video information is skipped. Therefore, at the time of the next reproduction, only necessary video can be reproduced by reading out and reproducing the edited video information of the area 82. Incidentally, also in the embodiment, “preserving video” may be displayed on the television monitor 13 during the push of the interval button 35 and “completion of preservation” may be displayed at a point in time of the release of the interval button 35.

In the above manner, according to each the embodiment described above, an interval for deleting or leaving the video information is designated by operating the interval button 35. In the case of deletion, information about the designated interval is skipped automatically and only the necessary video information is recorded in the area 82. In the case of leaving video, only the video information about the designated interval is recorded in the area 82. Therefore, at the time of the next reproduction, only the necessary video information can be reproduced by performing reproduction based on the video information recorded in the area 82. Also, in editing processing, in the case of deleting unnecessary video, it has only to be constructed so that video in an interval designated by the interval button 35 is skipped and is not recorded in the area 82, and in the case of leaving necessary video, only video in the designated interval has only to be recorded in the area 82, so that processing such as cluster number setting for connecting video before and after the deletion is unnecessary and the editing processing can be performed very simply.

Each the embodiment described above is constructed so as to perform editing processing based on the fact that the interval button 35 is operated at the time of reproduction, but it may be constructed so as to perform the editing processing on condition that that the interval button 35 is operated in a state of setting an editing mode. According to this, at the time of normal reproduction which is not the editing mode, there is no need to copy reproduced video to the area 82 of the hard disk 8, so that processing is more simplified and a load of the CPU 4 can be reduced. Incidentally, setting of the editing mode is made by operating the menu button 22 of the remote control 12 and displaying a menu on a screen of the television monitor 13 and selecting the editing mode in its menu.

Also, in the setting of the editing mode, it may be constructed so as to make transition to the editing mode automatically when the interval button 35 has been pushed down for a certain time (for example, two seconds) or longer in a normal mode. This is a method useful for the cases of the third and fourth embodiments described above. According to this, even in the case that the menu button 22 is not operated, mode setting and editing work can be performed by only the interval button 35 and it becomes easy for a user to perform an operation and ease of use improves.

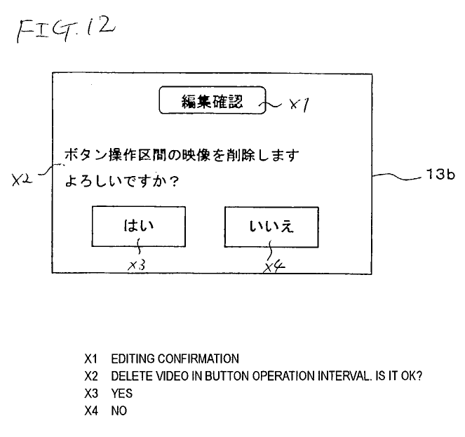

Also, each the embodiment described above may be constructed so as to be able to select whether to skip or leave video information about an interval designated by the interval button 35. This selection is made on a setting screen of the television monitor 13. FIG. 11 shows one example of this setting screen 13a, and setting is made by operating the cursor button 30 of the remote control 12 and selecting whether to leave or delete and pushing the OK key 31. According to this, a user can freely select any mode in consideration of ease of use.

Also, each the embodiment described above maybe constructed so that at the time of completing an editing operation (at the time of completing reproduction), for example, a confirmation screen 13b as shown in FIG. 12 is displayed on the television monitor 13 and an audience is prompted to confirm editing.

The invention can adopt various forms in addition to the above description. For example, in the embodiment described above, edited video is recorded in the area 82 of the hard disk 8, but it may be constructed so as to be recorded on recording means other than the hard disk 8, for example, an optical disk such as DVD-RAM or DVD-RW.

Also, in the embodiments described above, only one interval button 35 is provided, but in the case of designating an interval by two operations as shown in the first and second embodiments, a button pushed at the first time and a button pushed at the second time may be provided separately. Also, a button operated in the case of deleting video and a button operated in the case of leaving video may be provided independently. Further, in the embodiments described above, the dedicated interval button 35 is provided, but it may be constructed so as to serve as the interval button 35 using another button.

Also, in the embodiments described above, the case of editing the video information is taken as an example, but the invention can also be applied to the case of editing sound information similarly.

According to the invention, management of a cluster number becomes unnecessary and editing processing for deleting or leaving recorded information can be performed very simply.

What is claimed is:

1. A hard disk recorder comprising:
a hard disk having a first area in which video information is recorded at a time of recording and a second area in which the video information is copied and recorded at a time of reproducing the video information recorded in the first area,
wherein the hard disk recorder is operated by a remote control and digitizes video information input from the outside and records the video information on the hard disk, reads the recorded video information out of the hard disk, reproduces the video information and displays the reproduced video on a monitor,
when reproducing and editing recorded video of the first area, video in an interval from a point in time of the first pushdown of a specific button provided in the remote control to a point in time of the second pushdown of the specific button among reproduced video displayed on the monitor is skipped and only necessary video information is recorded in the second area, and
video is reproduced based on the video information recorded in the second area at the time of the next reproduction.

2. A hard disk recorder comprising:
a hard disk having a first area in which video information is recorded at a time of recording and a second area in which the video information is copied and recorded at a time of reproducing the video information recorded in the first area,
wherein the hard disk recorder is operated by a remote control and digitizes video information input from the outside and records the video information on the hard disk, reads the recorded video information out of the hard disk, reproduces the video information and displays the reproduced video on a monitor,
when reproducing and editing recorded video of the first area, video in an interval from a point in time of the first pushdown of a specific button provided in the remote control to a point in time of the second pushdown of the specific button among reproduced video displayed on the monitor is left and only the left video information is recorded in the second area, and
video is reproduced based on the video information recorded in the second area at the time of the next reproduction.

3. A hard disk recorder comprising:
a hard disk having a first area in which video information is recorded at a time of recording and a second area in which the video information is copied and recorded at a time of reproducing the video information recorded in the first area,
wherein the hard disk recorder is operated by a remote control and digitizes video information input from the outside and records the video information on the hard disk, reads the recorded video information out of the hard disk, reproduces the video information and displays the reproduced video on a monitor,
when reproducing and editing recorded video of the first area, video in an interval in which a specific button provided in the remote control has been pushed down among reproduced video displayed on the monitor is skipped and only necessary video information is recorded in the second area, and
video is reproduced based on the video information recorded in the second area at the time of the next reproduction.

4. A hard disk recorder comprising:
a hard disk having a first area in which video information is recorded at a time of recording and a second area in which the video information is copied and recorded at a time of reproducing the video information recorded in the first area,
wherein the hard disk recorder is operated by a remote control and digitizes video information input from the outside and records the video information on the hard disk, reads the recorded video information out of the hard disk, reproduces the video information and displays the reproduced video on a monitor,
when reproducing and editing recorded video of the first area, video in an interval in which a specific button provided in the remote control has been pushed down among reproduced video displayed on the monitor is left and only the video information is recorded in the second area, and
video is reproduced based on the video information recorded in the second area at the time of the next reproduction.

5. An information recording reproducing apparatus that is operated by a remote control and digitizes information input from the outside and records the information, and reads out and reproduces the recorded information, comprising:
a recording part for copying and recording the reproduced information at a time of reproducing the recorded information,
wherein when reproducing and editing the information, information in an interval designated by an operation of a specific button provided in the remote control is skipped or left and only necessary information is recorded in the recording part, and
reproduction is performed based on the information recorded in the recording part at the time of the next reproduction.

6. The information recording reproducing apparatus according to claim 5, wherein edit processing for skipping or leaving information in the designated interval is performed when the specific button is operated in a state where an editing mode is set.

7. An information recording reproducing apparatus according to claim 6, wherein transition to the editing mode is made automatically when the specific button has been pushed down for a certain time or longer.

8. An information recording reproducing apparatus according to claim 5, wherein the information in the designated interval is selectable whether to skip or leave.
